(19) United States
(12) Patent Application Publication
(10) Pub. No.: US 2026/0129308 A1
(43) Pub. Date: May 7, 2026

(54) Mitigating Flicker and Reducing Power Consumption in a Head-Mounted Device

(71) Applicant: Apple Inc., Cupertino, CA (US)

(72) Inventors: Daniel A Glynn, Seattle, WA (US); Simon Fortin-Deschenes, Santa Clara, CA (US); Luke A Pillans, Sunnyvale, CA (US); Joseph Cheung, San Jose, CA (US); Seyedkoosha Mirhosseini, Santa Clara, CA (US)

(21) Appl. No.: 19/086,745

(22) Filed: Mar. 21, 2025

Related U.S. Application Data
(60) Provisional application No. 63/715,129, filed on Nov. 1, 2024.

(51) Int. Cl. H04N 23/745; G02B 27/01; H04N 23/73

(52) U.S. Cl. CPC H04N 23/745; G02B 27/0172; H04N 23/73; G02B 2027/0138; G02B 2027/014

(57) ABSTRACT

A method of operating an electronic device such as a head-mounted device to mitigate flicker-related issues is provided. The method can include capturing first images of a physical environment at a first frequency, determining a frequency of a light source, capture second images of the physical environment at a second frequency different than the first frequency based on the frequency of the light source, and displaying warped images at a display frequency different than the second frequency. The warped images can be produced by warping a subset of the second images based on poses of the head-mounted device in the physical environment at times corresponding to when the subset of the second images are being captured at the second frequency and based on poses of the head-mounted device in the physical environment at times corresponding to when the warped images are being displayed at the display frequency.

This application claims the benefit of U.S. Provisional Patent Application No. 63/715,129, filed Nov. 1, 2024, which is hereby incorporated by reference herein in its entirety.

### FIELD

This relates generally to electronic devices, and, more particularly, to electronic devices such as head-mounted devices.

### BACKGROUND

Electronic devices such as head-mounted devices can have cameras for obtaining a live video feed of a physical environment and one or more displays for presenting the live video feed to a user. The physical environment can include one or more light sources.

The cameras can acquire images for the live video feed at some frame rate. The displays can output the live video feed at some frame rate. The light sources can be modulated at some frequency that is different than the frame rate of the cameras and displays. If care is not taken, the light sources in the environment can result in noticeable flicker in the live video feed. It is within such context that the embodiments herein arise.

### SUMMARY

An aspect of the disclosure provides a method for operating an electronic device such as a head-mounted device. The method can include: with one or more image sensors, capturing first images of a physical environment at a first frequency; determining a frequency of a light source in the physical environment; configuring the one or more image sensors to capture second images of the physical environment at a second frequency different than the first frequency based on the frequency of the light source; and with one or more displays, outputting warped images at a display frequency different than the second frequency. The warped images can be produced by warping a subset of the second images based on poses of the head-mounted device in the physical environment at times corresponding to when the subset of the second images are being captured at the second frequency and based on poses of the head-mounted device in the physical environment at times corresponding to when the warped images are being output on the one or more displays at the display frequency. Another subset of the second images different than the subset of the second images can be used for one or more of: exposure time evaluation, image sensor gain evaluation, clipping evaluation, high dynamic range (HDR) recovery, and two-dimensional brightness and color correction map generation.

An aspect of the disclosure provides a method of operating a head-mounted device that includes: detecting a light source in a physical environment and determining a frequency of the light source; with one or more image sensors, capturing images of the physical environment while capture time periods used for capturing the images are aligned to peaks of the light source; and with one or more displays, outputting a first subset of the images at a display frequency different than the frequency of the light source. The first subset of the images being output on the one or more displays at the display frequency can be captured using a first set of image sensor settings while a second subset of the images, different than the first subset of the images, can be captured using a second set of image sensor settings at least partially different than the first set of image sensor settings. The second subset of the images captured using the second set of image sensor settings are not being output on the one or more displays.

An aspect of the disclosure provides a method of operating a head-mounted device in a physical environment, including: with one or more cameras, capturing images at a first cadence; with one or more displays, outputting a first subset of the images at a second cadence different than the first cadence; selectively dropping a second subset of the images different than the first subset of the images; and warping the first subset of the images based on capture times of the first subset of the images and based on display times of the first subset of the images on the one or more displays prior to outputting the first subset of the images on the one or more displays.

### BRIEF DESCRIPTION OF THE DRAWINGS

FIG. 1 is a top view of an illustrative head-mounted device in accordance with some embodiments.

FIG. 2 is a schematic diagram of an illustrative electronic device in accordance with some embodiments.

FIG. 3 is a diagram of an illustrative electronic device having hardware and/or software subsystems configured to perform frequency and phase locking in accordance with some embodiments.

FIG. 4 is an overhead perspective view of an illustrative electronic device in a physical environment.

FIG. 5A illustrates a first view of the physical environment of FIG. 4 at a first time as would be seen by a user's left eye if the user were not wearing the electronic device.

FIG. 5B illustrates a first image of the physical environment of FIG. 4 captured by a left image sensor of the electronic device at the first time.

FIG. 5C illustrates a second view of the physical environment of FIG. 4 at a second time as would be seen by the user's left eye if the user were not wearing the electronic device.

FIG. 5D illustrates a second image of the physical environment of FIG. 4 captured by the left image sensor over a capture time period including the first time.

FIG. 6 is a timing diagram showing illustrative warping operations in accordance with some embodiments.

FIG. 7 is a diagram of an illustrative electronic device having a warp producer configured to generate warped images based on one or more predicted poses in accordance with some embodiments.

FIG. 8 is a flow chart of illustrative steps for operating an electronic device of the type shown in connection with FIGS. 1-7 in accordance with some embodiments.

FIG. 9 is a timing diagram showing illustrating warping operations that can be performed for at least some of the captured images in accordance with some embodiments.

### DETAILED DESCRIPTION

An electronic device such as a head-mounted device can be mounted on a user's head and may have a front face that faces away from the user's head and an opposing rear face that faces the user's head. One or more sensors on the front face of the device, sometimes referred to as “front-facing” cameras, may be used to obtain a live passthrough video stream of the external physical environment. One or more displays on the rear face of the device may be used to present the live passthrough video stream to the user's eyes.

A physical environment refers to a real-world environment that people can sense and/or interact with without the aid of an electronic device. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics.

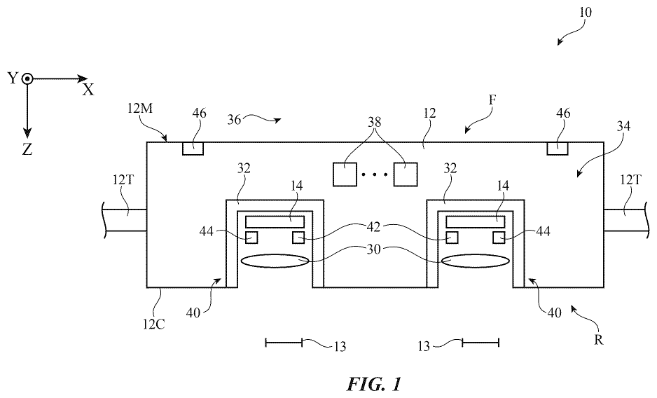

A top view of an illustrative head-mounted device is shown in FIG. 1. As shown in FIG. 1, head-mounted devices such as electronic device 10 may have head-mounted support structures such as housing 12. Housing 12 may include portions (e.g., head-mounted support structures 12T) to allow device 10 to be worn on a user's head. Support structures 12T may be formed from fabric, polymer, metal, and/or other material. Support structures 12T may form a strap or other head-mounted support structures to help support device 10 on a user's head. A main support structure (e.g., a head-mounted housing such as main housing portion 12M) of housing 12 may support electronic components such as displays 14.

Main housing portion 12M may include housing structures formed from metal, polymer, glass, ceramic, and/or other material. For example, housing portion 12M may have housing walls on front face F and housing walls on adjacent top, bottom, left, and right side faces that are formed from rigid polymer or other rigid support structures, and these rigid walls may optionally be covered with electrical components, fabric, leather, or other soft materials, etc. Housing portion 12M may also have internal support structures such as a frame (chassis) and/or structures that perform multiple functions such as controlling airflow and dissipating heat while providing structural support. The walls of housing portion 12M may enclose internal components 38 in interior region 34 of device 10 and may separate interior region 34 from the environment surrounding device 10 (exterior region 36). Internal components 38 may include integrated circuits, actuators, batteries, sensors, and/or other circuits and structures for device 10. Housing 12 may be configured to be worn on a head of a user and may form glasses, spectacles, a hat, a mask, a helmet, goggles, and/or other head-mounted device. Configurations in which housing 12 forms goggles may sometimes be described herein as an example.

Front face F of housing 12 may face outwardly away from a user's head and face. Opposing rear face R of housing 12 may face the user. Portions of housing 12 (e.g., portions of main housing 12M) on rear face R may form a cover such as cover 12C (sometimes referred to as a curtain). The presence of cover 12C on rear face R may help hide internal housing structures, internal components 38, and other structures in interior region 34 from view by a user.

Device 10 may have one or more cameras such as cameras 46 of FIG. 1. Cameras 46 that are mounted on front face F and that face outwardly (towards the front of device 10 and away from the user) may sometimes be referred to herein as “forward-facing” or “front-facing” cameras. Cameras 46 may capture visual odometry information, image information that is processed to locate objects in the user's field of view (e.g., so that virtual content can be registered appropriately relative to real-world objects), image content that is displayed in real time for a user of device 10, and/or other suitable image data. For example, forward-facing (front-facing) cameras may allow device 10 to monitor movement of the device 10 relative to the environment surrounding device 10 (e.g., the cameras may be used in forming a visual odometry system or part of a visual inertial odometry system). Forward-facing cameras may also be used to capture images of the environment that are displayed to a user of the device 10. If desired, images from multiple forward-facing cameras may be merged with each other and/or forward-facing camera content can be merged with computer-generated content for a user.

Device 10 may have any suitable number of cameras 46. For example, device 10 may have K cameras, where the value of K is at least one, at least two, at least four, at least six, at least eight, at least ten, at least 12, less than 20, less than 14, less than 12, less than 10, 4-10, or other suitable value. Cameras 46 may be sensitive at infrared wavelengths (e.g., cameras 46 may be infrared cameras), may be sensitive at visible wavelengths (e.g., cameras 46 may be visible cameras), and/or cameras 46 may be sensitive at other wavelengths. If desired, cameras 46 may be sensitive at both visible and infrared wavelengths.

Device 10 may have left and right optical modules 40. Optical modules 40 support electrical and optical components such as light-emitting components and lenses and may therefore sometimes be referred to as optical assemblies, optical systems, optical component support structures, lens and display support structures, electrical component support structures, or housing structures. Each optical module may include a respective display 14, lens 30, and support structure such as support structure 32. Support structure 32, which may sometimes be referred to as a lens support structure, optical component support structure, optical module support structure, or optical module portion, or lens barrel, may include hollow cylindrical structures with open ends or other supporting structures to house displays 14 and lenses 30. Support structures 32 may, for example, include a left lens barrel that supports a left display 14 and left lens 30 and a right lens barrel that supports a right display 14 and right lens 30.

Displays 14 may include arrays of pixels or other display devices to produce images. Displays 14 may, for example, include organic light-emitting diode pixels formed on substrates with thin-film circuitry and/or formed on semiconductor substrates, pixels formed from crystalline semiconductor dies, liquid crystal display pixels, scanning display devices, and/or other display devices for producing images.

Lenses 30 may include one or more lens elements for providing image light from displays 14 to respective eyes boxes 13. Lenses may be implemented using refractive glass lens elements, using mirror lens structures (catadioptric lenses), using Fresnel lenses, using holographic lenses, and/or other lens systems.

When a user's eyes are located in eye boxes 13, displays (display panels) 14 operate together to form a display for device 10 (e.g., the images provided by respective left and right optical modules 40 may be viewed by the user's eyes in eye boxes 13 so that a stereoscopic image is created for the user). The left image from the left optical module fuses with the right image from a right optical module while the display is viewed by the user.

It may be desirable to monitor the user's eyes while the user's eyes are located in eye boxes 13. For example, it may be desirable to use a camera to capture images of the user's irises (or other portions of the user's eyes) for user authentication. It may also be desirable to monitor the direction of the user's gaze. Gaze tracking information may be used as a form of user input and/or may be used to determine where, within an image, image content resolution

should be locally enhanced in a foveated imaging system. To ensure that device 10 can capture satisfactory eye images while a user's eyes are located in eye boxes 13, each optical module 40 may be provided with a camera such as camera 42 and one or more light sources such as light-emitting diodes 44 or other light-emitting devices such as lasers, lamps, etc. Cameras 42 and light-emitting diodes 44 may operate at any suitable wavelengths (visible, infrared, and/or ultraviolet). As an example, diodes 44 may emit infrared light that is invisible (or nearly invisible) to the user. This allows eye monitoring operations to be performed continuously without interfering with the user's ability to view images on displays 14.

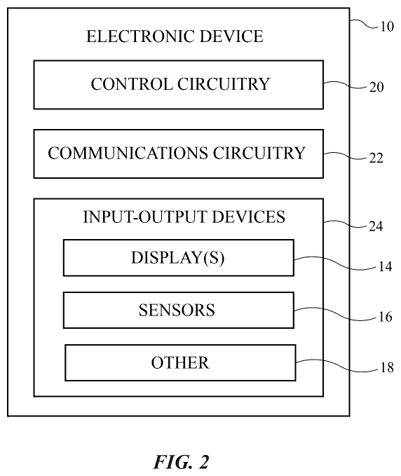

A schematic diagram of an illustrative electronic device such as a head-mounted device or other wearable device is shown in FIG. 2. Device 10 of FIG. 2 may be operated as a stand-alone device and/or the resources of device 10 may be used to communicate with external electronic equipment. As an example, communications circuitry in device 10 may be used to transmit user input information, sensor information, and/or other information to external electronic devices (e.g., wirelessly or via wired connections). Each of these external devices may include components of the type shown by device 10 of FIG. 2.

As shown in FIG. 2, a head-mounted device such as device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use display(s) 14 and other output devices in providing a user with visual output and other output.

To support communications between device 10 and external equipment, control circuitry 20 may communicate using communications circuitry 22. Circuitry 22 may include antennas, radio-frequency transceiver circuitry, and other wireless communications circuitry and/or wired communications circuitry. Circuitry 22, which may sometimes be referred to as control circuitry and/or control and communications circuitry, may support bidirectional wireless communications between device 10 and external equipment (e.g., a companion device such as a computer, cellular telephone, or other electronic device, an accessory such as a point device or a controller, computer stylus, or other input device, speakers or other output devices, etc.) over a wireless link. For example, circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link. Wireless communications may, for example, be supported over a Bluetooth® link, a WiFi® link, a wireless link operating at a frequency between 10 GHz and 400 GHz, a 60 GHz link, or other millimeter wave link, a cellular telephone link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display(s) 14. Display(s) 14 may include one or more display devices such as organic light-emitting diode display panels (panels with organic light-emitting diode pixels formed on polymer substrates or silicon substrates that contain pixel control circuitry), liquid crystal display panels, microelectromechanical systems displays (e.g., two-dimensional mirror arrays or scanning mirror display devices), display panels having pixel arrays formed from crystalline semiconductor light-emitting diode dies (sometimes referred to as microLEDs), and/or other display devices.

Sensors 16 in input-output devices 24 may include force sensors (e.g., strain gauges, capacitive force sensors, resistive force sensors, etc.), audio sensors such as microphones, touch and/or proximity sensors such as capacitive sensors such as a touch sensor that forms a button, trackpad, or other input device), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors (e.g., cameras), fingerprint sensors, iris scanning sensors, retinal scanning sensors, and other biometric sensors, temperature sensors, sensors for measuring three-dimensional non-contact gestures (“air gestures”), pressure sensors, sensors for detecting position, orientation, and/or motion of device 10 and/or information about a pose of a user's head (e.g., accelerometers, magnetic sensors such as compass sensors, gyroscopes, and/or inertial measurement units that contain some or all of these sensors), health sensors such as blood oxygen sensors, heart rate sensors, blood flow sensors, and/or other health sensors, radio-frequency sensors, three-dimensional camera systems such as depth sensors (e.g., structured light sensors and/or depth sensors based on stereo imaging devices that capture three-dimensional images) and/or optical sensors such as self-mixing sensors and light detection and ranging (lidar) sensors that gather time-of-flight measurements (e.g., time-of-flight cameras), humidity sensors, moisture sensors, gaze tracking sensors, electromyography sensors to sense muscle activation, facial sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input (e.g., voice commands), accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, actuators for moving movable housing structures, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

Display(s) 14 can be used to present a variety of content to a user's eye. The left and right displays 14 that are used to present a fused stereoscopic image to the user's eyes when viewing through eye boxes 13 can sometimes be referred to collectively as a display 14. In one scenario, the user might be reading static content in a web browser on display 14. In another scenario, the user might be viewing dynamic content such as movie content in a web browser or a media player on display 14. In another scenario, the user might be viewing video game (gaming) content on display 14. In another scenario, the user might be viewing a live feed of the environment surrounding device 10 that is captured using the one or more front-facing camera(s) 46. If desired, computer-generated (virtual) content can be overlaid on top of one or more portions of the live feed presented on display 14. In another scenario, the user might be viewing a live event recorded elsewhere (e.g., at a location different than the location of the user) on display 14. In another scenario, the user might be conducting a video conference (a live meeting) using device 10 while viewing participants and/or any shared meeting content on display 14. These examples are merely illustrative. In general, display 14 can be used to output any type of image or video content.

A physical environment, sometimes referred to herein as a “scene,” in which device 10 is being operated can include one or more light sources. A light source can exhibit some modulation frequency. In general, scenarios where the frequency of a light source is close to a frame rate of the front-facing camera(s) used to capture a live video feed of the scene can result in strong judder and double images. Judder can refer to or be defined herein as a visual artifact that appears as a noticeable jerkiness or stuttering in the motion of objects on display(s) 14. Judder can be caused by the light source acting as a strobe producing light pulses that are not aligned with the camera frame exposure/capture periods. If an object in the scene being captured and/or if device 10 itself is in constant motion (e.g., if the user is turning or rotating his/her head while operating device 10), then the motion in the resulting image will not be constant. If not mitigated, judder can cause the user to experience motion sickness.

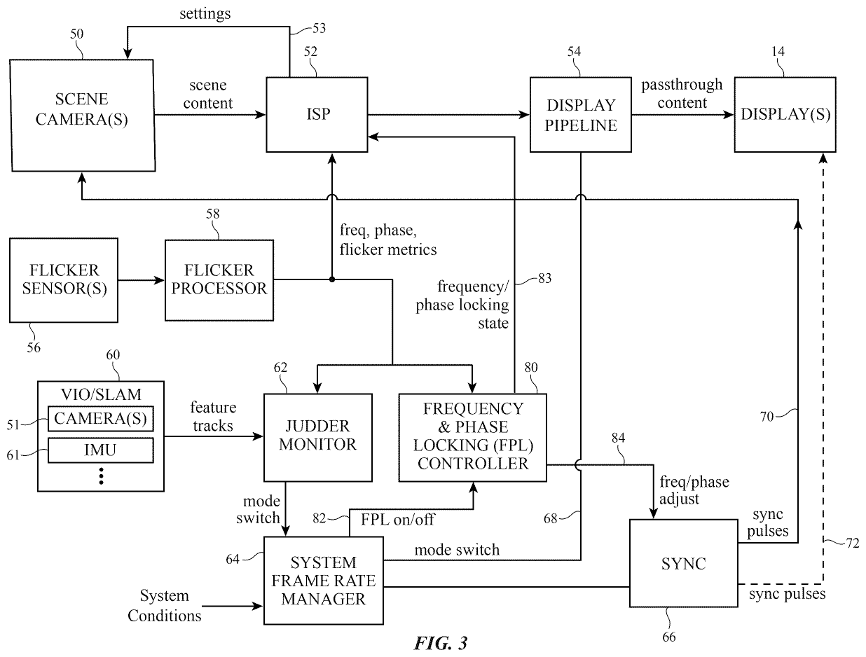

In accordance with some embodiments, FIG. 3 shows hardware and/or software subsystems that can be included within device 10 for mitigating judder and/or flicker by locking the frequency and/or phase of a system clock to the frequency and/or phase of a detected flicker-causing light source. A “flicker-causing” light source can refer to a light source having a modulation frequency illuminating a scene being captured by the front-facing cameras of device 10, where the corresponding captured image or video feed exhibits flicker. Flicker can generally refer to rapid noticeable variations in brightness and/or color that can make a video appear unstable or visually jarring. A “system clock” may refer to and be defined herein as a clock signal that sets the system frame rate of device 10 (e.g., a clock signal that determines the camera frame rate and/or the display frame rate). The frame rate of display(s) 14 is sometimes referred to and defined herein as the “display frequency” or display operating frequency.

As shown in FIG. 3, device 10 may include one or more sensors such as scene cameras 50 and flicker sensor(s) 56, image signal processing (ISP) block 52, display pipeline 54, one or more display(s) 14, flicker processor 58, a judder monitoring subsystem such as judder monitor 62, a motion and position determination subsystem such as visual-inertial odometry (VIO) and simultaneous localization and mapping (SLAM) block 60, a system frame rate management subsystem such as system frame rate manager 64, a synchronization subsystem such as synchronization pulse generator 66, and a controller such as frequency and phase locking (FPL) control block 80.

One or more cameras 50 can be used to gather information on the external real-world environment surrounding device 10. Cameras 50 may include one or more of front-facing cameras 46 of the type shown in FIG. 1. At least some of cameras 50 may be configured to capture a series of images of a scene, which can be processed and presented as a live video passthrough feed to the user using displays 14. The live video passthrough feed is sometimes referred to as video passthrough content. Such front-facing cameras 50 that are employed to acquire passthrough content are sometimes referred to as scene or passthrough cameras. Cameras 50 may include color image sensors and/or optionally monochrome (black and white) image sensors. Cameras 50 can have different fields of view (e.g., some cameras can have a wide or ultrawide field of view, whereas some cameras can have relatively narrower field of view). Not all of cameras 50 need to be used for capturing passthrough content. Some of the cameras 50 may be forward facing (e.g., oriented towards the scene in front of the user); some of the cameras 50 may be downward facing (e.g., oriented towards the user's torso, hands, or other parts of the user); some of the cameras 50 may be side/lateral facing (e.g., oriented towards the left and right sides of the user); and some of the cameras 50 can be oriented in other directions relative to the front face of device 10. All of these cameras 50 that are configured to gather information on the external physical environment surrounding device 10 are sometimes referred to and defined collectively as “external-facing” cameras.

Cameras 50 can be configured to acquire and output raw images of a scene. The raw images output from cameras 50, sometimes referred to herein as scene content, can be processed by image signal processor (ISP) 52. Image signal processing block 52 can be configured to perform image signal processing functions that rely on the input of the raw images themselves. For example, ISP block 52 may be configured to perform automatic exposure for controlling an exposure setting for the passthrough feed, tone mapping, autofocus, color correction, gamma correction, shading correction, noise reduction, black level adjustment, demosaicing, image sharpening, high dynamic range (HDR) correction, color space conversion, and/or other image signal processing functions to output a corresponding processed passthrough feed (e.g., a series of processed video frames). ISP block 52 can be configured to adjust settings of scene cameras 50 such as to adjust a gain, an exposure time, and/or other settings of cameras 50, as illustrated by control path 53. The processed images, sometimes referred to and defined herein as video passthrough content, can be presented as a live video stream/feed to the user via one or more displays 14.

Flicker sensor 56 can represent a dedicated light detector or meter configured to measure and detect variations in the intensity of light, typically caused by fluctuations in the amplitude of one or more light sources in a scene. For example, light sources in the United States (US) are commonly modulated at a frequency of 120 Hz since the alternating current supplied by US power grids typically oscillate at 60 cycles per second. As another example, light sources in European countries are commonly modulated at a frequency of 100 Hz. The raw sensor data output by flicker sensor 56 can be processed using flicker processor 58.

Flicker processor 58 can be configured to analyze the raw sensor data received from flicker sensor 56 and to measure/compute corresponding flicker metrics such as frequency, phase, modulation depth, flicker index (e.g., a metric that considers both the modulation depth and the flicker frequency), a DC or direct current ratio (e.g., a ratio of the energy of constant light to the energy of flickering light), and other related lighting information. A scene can include a plurality of light sources. Some of the light sources in the scene can have the same modulation frequency, and some of the light sources can have different modulation frequencies. The flicker frequency output from flicker processor 58 may represent the frequency of the dominant light source in the physical environment or scene. The phase output from flicker processor 58 may represent the phase of the dominant light source in the scene. The “dominant” light source can refer to or be defined as the primary or most prevalent light source in a given environment or scene (e.g., the light source with the most significant influence on the overall illumination and color perception in that scene). In some embodiments, flicker sensor 56 might be able to detect the frequency and phase of multiple light sources in the physical environment. If desired, flicker sensor 56 can sense the overall lighting of the scene and detect the frequency and phase of each of the light sources, including the frequency of the dominant light source (e.g., flicker sensor 56 can have a different output for each light source detected within the scene).

Block 60 can include one or more external-facing camera(s) 51, an inertial measurement unit (IMU) 61, one or more depth/distance sensors, and/or other sensors. Camera(s) 51, which can optionally be part of scene cameras 50, front-facing cameras 46 of FIG. 1, or other external-facing cameras, can be configured to gather visual information on the scene. The inertial measurement unit (IMU) 61 can include one or more gyroscopes, gyrocompasses, accelerometers, magnetometers, other inertial sensors, and other position and motion sensors. The yaw, roll, and pitch of the user's head, which represent three degrees of freedom (DOF), may collectively define a user's orientation. The user's orientation along with a position of the user, which represent three additional degrees of freedom (e.g., X, Y, Z in a 3-dimensional space), can be collectively defined herein as the user's pose. The user's pose therefore represents six degrees of freedom. These position and motion sensors may assume that head-mounted device 10 is mounted on the user's head. Therefore, references herein to head pose, head movement, yaw of the user's head (e.g., rotation around a vertical axis), pitch of the user's head (e.g., rotation around a side-to-side axis), roll of the user's head (e.g., rotation around a front-to-back axis), etc. may be considered interchangeable with references to device pose, device movement, yaw of the device, pitch of the device, roll of the device, etc. In certain embodiments, IMU 61 may also include 6 degrees of freedom (DoF) tracking sensors, which can be used to monitor both rotational movement such as roll, pitch, and yaw and also positional/translational movement in a 3D environment.

Block 60 can include a visual-inertial odometry (VIO) subsystem that combines the visual information from cameras 51, the data from IMU 61, and optionally measurement data from other sensors within device 10 to estimate the motion of device 10. Additionally or alternatively, block 60 can include a simultaneous localization and mapping (SLAM) subsystem that combines the visual information from cameras 50, the data from IMU 61, and optionally measurement data from other sensors within device 10 to construct a 2D or 3D map of a physical environment while simultaneously tracking the location and/or orientation of device 10 within that environment. Configured in this way, block 60 (sometimes referred to as a VIO/SLAM block or a motion and location determination subsystem) can be configured to output motion information, location information, pose/orientation information, and other positional information associated with device 10 within a physical environment.

In accordance with some embodiments, VIO/SLAM block 60 can also be configured to generate feature tracks. Feature tracks (sometimes also referred to as feature traces) can refer to visual elements that define the structure and appearance of objects in an image such as distinctive patterns, lines, edges, textures, shapes, and/or other visual cues that allow computer vision systems to recognize and differentiate between different objects in a scene. Features tracks can be used as another data point for detecting or monitoring judder during motion of device 10. Feature tracks can thus be used to perform image space judder detection (e.g., judder monitor 62 can determine whether to operate the electronic in the first/default mode or the second mode based on the feature tracks). VIO/SLAM block 60 can optionally include one or more sub-blocks configured to perform feature detection, feature description, and/or feature matching. These feature-related subblocks can be used for both VIO/SLAM functions and for judder detection. Alternatively, judder detection operations can be performed using an optical flow that does not rely on these subblocks of VIO/SLAM block 60.

Judder monitoring block 62 can be configured to receive the frequency, phase, and/or other flicker metrics as computed by flicker processor 58, to optionally receive feature tracks or other motion/positional parameters from block 60, and to determine a degree or severity of judder present in the captured scene content. The frequency and other flicker metrics computed by flicker processor 58 can also be conveyed to ISP block 52 to facilitate in the image processing functions at ISP block 52. Based on the received information, judder monitor 62 can be configured to compute a judder severity parameter (or factor) that reflects how severe or apparent judder might be in the scene content. A high(er) judder severity parameter may correspond to scenarios where judder, double images, and/or ghosting are likely to result in the user experiencing motion sickness. Thus, when the judder severity parameter computed by judder monitor 62 exceeds a certain threshold (sometimes referred to herein as a judder severity threshold), judder monitor 62 may output a mode switch signal directing device 10 to adjust the frequency and/or phase of the system clock to help mitigate judder caused by one or more flicker-causing light sources.

The mode switch signal output from judder monitor 62 can be received by system frame rate manager 64. System frame rate manager 64 may be a component responsible for controlling a system frame rate of device 10. The “system frame rate” can refer to the camera frame rate (e.g., the rate at which exposures are being performed by scene cameras 50) and/or the display frame rate (e.g., the rate at which video frames are being output on displays 14). Device 10 may have a unified system frame rate where the camera frame rate is set equal to (or synchronized with) the display frame rate. This is exemplary. In other embodiments, device 10 can optionally be operated using unsynchronized system frame rates where the camera frame rate is not equal to the display frame rate.

System frame rate manager 64 may determine whether to adjust the system frame rate of device 10. System frame rate manager 64 can decide whether to adjust the system frame rate based on the mode switch signal output from judder monitor 62 and/or based on one or more system conditions. For instance, the system conditions can include information about a current user context (or mode) under which device 10 is being operated. As examples, device 10 can be operated in a variety of different extended reality modes, including but not limited to an immersive media mode, a multiuser communication session mode, a spatial capture mode, and a travel mode, just to name a few.

In accordance with some embodiments, system frame rate manager 64 may be restricted from adjusting the frequency and/or phase of the system clock while device 10 is operated in the immersive media mode or the multiuser communication session mode (e.g., device 10 should not change frame rates during a game or video call). Other system conditions that might affect whether manager 64 adjusts any attributes associated with the system clock may include an operating temperature of device 10, a power consumption level of device 10, a battery level of device 10, or other operating condition(s) of device 10. Assuming the system conditions allow for some kind of adjustment to the system clock signal, system frame rate manager 64 may output a mode switch signal to display pipeline 54 via path 68 for indicating to the display pipeline that device 10 is adjusting the system clock. Display pipeline 54 may generally represent any component for processing the passthrough content between ISP block 52 and display(s) 14. Although display pipeline 54 is illustrated as being separate from ISP block 52 and display(s) 14, any components that are involved in the processing and/or rendering of visual content, including real-world passthrough content or computer-generated virtual content, to be presented on display(s) 14 can be considered part of the display pipeline. The mode switch signal output from judder monitor 62 may direct device 10 to operate in at least two different modes such as a first (default) mode and a second mode configured to mitigate judder, double images, ghosting, and other undesired display artifacts. The second mode is therefore sometimes referred to as a judder-mitigation mode.

System frame rate manager 64 may be configured to selectively activate and deactivate the frequency and phase locking controller 80 (e.g., by sending an activation or deactivation command to controller 80 via path 82). For example, in response to receiving a mode switch signal from judder monitor 62 directing device 10 to switch from the first (default) mode to the second (judder-mitigation) mode, system frame rate manager 64 may activate the frequency and phase locking controller 80. When device 10 is operated in the judder-mitigation mode, the exposure time (duration) of the scene cameras 50 can optionally be lowered as a function of flicker frequency (i.e., the frequency of the flicker-causing light source) to reduce static banding that would otherwise move across the frame. If desired, a spatially varying gain can also be applied to the acquired images to compensate for static banding. In response to receiving a mode switch signal from judder monitor 62 directing device 10 to switch from the judder-mitigation mode back to the default mode, system frame rate manager 64 may deactivate the frequency and phase locking controller 80.

Frequency and phase locking controller 80 may be configured to receive the frequency, phase, and/or other flicker metrics as computed by flicker processor 58. When activated, frequency and phase locking controller 80 may output frequency and phase adjustment signals to synchronization block 66. Frequency and phase locking controller 80 can also send frequency and phase locking state information to ISP block 52, as shown by data path 83. The frequency and phase adjustment signals output from FPL controller 80 ensures that the system clock has a frequency that is locked to (e.g., set equal to an integer ratio) the frequency of the detected (flicker-causing) light source and/or a phase that is locked (aligned) to the phase of the detected light source. For example, if the flicker frequency is 200 Hz, the system clock can be locked to 100 fps, 66.67 fps, 50 fps, 40 fps, etc. When deactivated, frequency and phase locking controller 80 may not output any frequency and phase adjustment signals to synchronization block 66.

Synchronization pulse generator 66 may be configured to generate synchronization pulses such as a first set of synchronization pulses that are conveyed to cameras 50 via path 70 and a second set of synchronization pulses that are conveyed to displays 14 via path 72. The first set of synchronization pulses can set the frame rate or exposure frequency of cameras 50. The second set of synchronization pulses can set the frame rate of displays 14. The first and second sets of synchronization pulses can optionally be synchronized to set the camera frame rate equal to the display frame rate. The first and second set of synchronization pulses can be referred to collectively as the “system clock.”

When activated, FPL controller 80 can send the frequency and phase adjustment signals to block 66 and in response, block 66 can output synchronization pulses (system clock) at a frequency that is equal (locked) to the frequency of the detected light source and having a phase that is aligned (locked) to the phase of the detected light source. For example, “phase-locking” can refer to or be defined herein as aligning the center (mid) point of each emitted light signal to the center (mid) point of each corresponding camera exposure period. In other words, the exposure periods of cameras 50 can be shifted based on the phase of the sensed light as computed by flicker processor 58. Configurations in which FPL controller 80 performs frequency and phase locking are illustrative. In other embodiments, FPL controller 80 can be configured to perform frequency locking without phase locking (e.g., the system clock can have a frequency matching the frequency of the flicker-causing light source but can exhibit a phase that is not necessarily aligned to the phase of that light source).

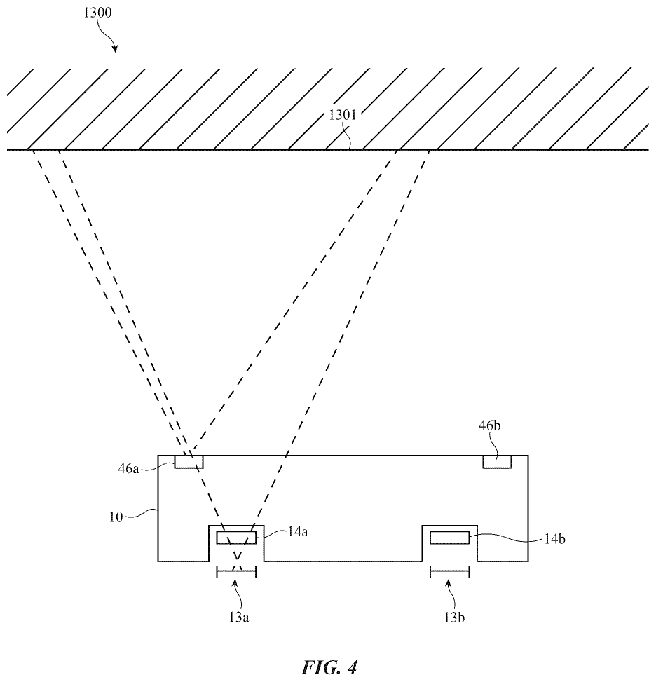

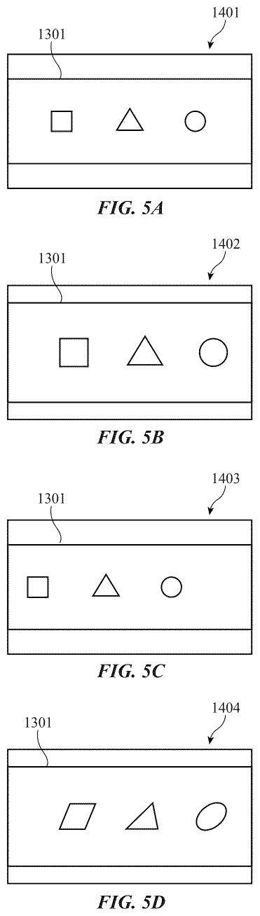

In accordance with some embodiments, device 10 can be configured to transform captured images based on estimated or predicted poses of device 10. Such type of image processing operation is described below in connection with FIGS. 4-9. FIG. 4 is an overhead perspective view of device 10 within a physical environment 1300. Physical environment 1300 can include a structure 1301 facing device 10. Structure 1301, as illustrated in the views and images described below with respect to FIGS. 5A-5D, has, painted thereon, a square, a triangle, and a circle. Left eye box 13a represents a left eye perspective of a user of device 10, whereas right eye box 13b represents a right eye perspective of the user. First external-facing camera 46a has a left image sensor (camera) perspective, whereas second external-facing camera 46b has a right image sensor (camera) perspective. Because left eye box 13a and first (left) camera 46a are at different locations, they each provide a different perspective of the physical environment 1300. Similarly, because right eye box 13b and second (right) camera 46b are at different locations, they each provide a different perspective (or view) of the physical environment 1300. Moreover, device 10 can have left eye display 14a within a field of view from the left eye box 13a and right eye display 14b within a field of view from the right eye box 13b.

FIG. 5A illustrates a first view 1401 of the physical environment 1300 at a first time as would be seen from the perspective of left eye box 13a if the user were not wearing device 10. In the first view 1401, the square, triangle, and the circle can be seen on structure 1301.

FIG. 5B illustrates a first image 1402 of the physical environment 1300 captured by the left camera 46a at the first time. The first image 1402 is therefore sometimes referred to as a first “captured” image. Similar to the first view 1401 of FIG. 5A, the first captured image 1402 shows the square, the triangle, and the circle on structure 1301. However, because the left camera 46a is positioned to the left of left eye box 13a (as shown in the example of FIG. 4), the triangle and the circle on structure 1301 in the first captured image 1402 are at locations to the right of the corresponding locations of the triangle and the circle in the first view 1401. Further, because the left camera 46a is closer to structure 1301 than left eye box 13a, the square, the triangle, and the circle appear larger in the first captured image 1402 than in the first view 1401.

Device 10 can be configured to optionally transform the first captured image 1402 to make it appear as though it was captured from the perspective of left eye box 13a at the first time rather than from the perspective of left camera 46a at the first time (e.g., so that the captured image appears identical to the first view 1401). Such transformation may be a projective transformation and is sometimes referred to as an image reprojection. Device 10 can transform the first captured image 1402 based on depth values associated with the first captured image 1402 and a difference between the left camera perspective at the first time and the left eye perspective at the first time. The depth value for a pixel of the first captured image 1402 may represent the distance from the left camera 46a to an object in the physical environment 1300 represented by that pixel. The difference between the left camera perspective at the first time and the left eye perspective at the first time can be determined via a calibration procedure.

FIG. 5C illustrates a second view 1403 of the physical environment 1300 at a second time as would be seen from the left eye box 13a if the user were not wearing device 10. Between the first time and the second time, the user has moved and/or rotated his/her to the right (as an example). Accordingly, in the second view 1403, the square, the triangle, and the circle can be seen on structure 1301 at locations to the left of the corresponding locations of the square, the triangle, and the circle in the first view 1401.

Transforming and displaying the first captured image 1402 can take time. Thus, when the first captured image 1402 is being transformed to appear as the first view 1401 and then output on the left display 14a at the second time, the transformed first captured image 1402 may not correspond to what the user would have seen if device 10 were not present (e.g., the transformed image may not correspond to the second view 1403) if the user moves or changes his head pose.

To help address this problem, device 10 may be configured to transform the first captured image 1402 so that it appears as though image 1402 was captured from the left eye perspective at the second time rather than from the left camera perspective at the first time (e.g., so that the transformed image appears as the second view 1403 of FIG. 5C). Device 10 can transform the first captured image 1402 based on depth values associated with captured image 1402 and a difference between the left camera perspective at the first time and the left eye perspective at the second time. The difference between the left camera perspective at the first time and the left eye perspective at the first time can be determined via a calibration procedure. The difference between the left eye perspective at the first time and the left eye perspective at the second time can be determined based on predicting or estimating a change in the pose of device 10 between the first time and the second time. The change in pose of device 10 can be predicted or estimated based on a motion of device 10 at the first time, such as the speed and/or acceleration, rotationally and/or translationally. From these two differences, the difference between the left camera perspective at the first time and the left eye perspective at the second time can be determined.

In some embodiments, the left camera 46a can be a rolling shutter image sensor. In such embodiments, the left camera 46a can capture an image over an image capture time period. The image capture time period can include a plurality of exposure time periods that are staggered in time. For example, each line of the left camera 46a can be exposed over a different exposure time period and following the exposure time period, the resulting values can be read out over a corresponding readout time period. To keep the exposure time constant, the exposure time period for each line after the first line can begin a readout time period after the exposure of the previous line starts.

FIG. 5D illustrates a second image 1404 of the physical environment 1300 captured by the left camera 46a over a capture time period including the first time. The second image 1404 is therefore sometimes referred to as the second “captured” image. Because the left camera 46a is to the left of the left eye box 13a, the triangle and the circle on the structure 1301 in the second captured image 1404 are at locations to the right of the corresponding locations of the triangle and the circle in the first view 1401. Moreover, because the left camera 46a is closer to the structure 1301 than the left eye box 13a, the square, the triangle, and the circle appear larger in the second captured image 1404 than in the first view 1401. If the user did not move during the capture time period, then the second image 1404 would appear identical to the first captured image 1402 shown in FIG. 5B. However, because the user did move during the capture time period, the square, the triangle, and the circle as seen on structure 1301 would be skewed as shown in the second captured image 1404 in FIG. 5D.

To help address this skew due to user movement, device 10 can be configured to transform the second captured image 1404 to make it appear as though it was captured from the left eye perspective at the second time rather than from the left camera perspective over the capture time period (e.g., so that the transformed image appears as the second view 1403 as shown in FIG. 5C). Device 10 can transform the second captured image 1404 based on depth values associated with the second captured image 1404 and a difference between the left camera perspective at the first time and the left eye perspective at the second time. Device 10 can also transform the second captured image 1404 based on motion of device 10 during the capture time period to compensate for skew introduced by the motion of device 10 during the capture time period.

Transforming the second captured image 1404 can include generating a definition of a transform and applying the transform to the second captured image 1404. To reduce latency, device 10 can generate the definition of the transform before or while the second image 1404 is being captured. In some embodiments, device 10 can generate the definition of the transform based on a predicted pose of device 10 at the first time and a predicted pose of device 10 at the second time. As an example, the first time can be the start of the capture time period. As another example, the first time can be the middle of the capture time period (e.g., halfway between the start of the capture time period and the end of the capture time period). As another example, the first time can be at any instant of the capture time period during which image 1404 is being captured. If desired, device 10 can generate the definition of the transform based on a predicted motion of device 10 during the capture time period to compensate for skew introduced by motion of device 10 during the capture time period.

In some embodiments, the displays of device 10 can optionally be a rolling display, where the displays update each line of pixels in a sequential (rolling) manner from top to bottom, or vice versa. Thus, the left display 14a can display a transformed image over a display time period. For example, each line of the transformed image can be emitted during a different emission time period and following the emission time period, the line can persist over a corresponding persistence time period. The “persistence time period” can refer to and be defined herein as a time period following the emission time period for which an image persists on the display. A “display time period” can thus refer to and be defined herein as the sum of the emission time period and the persistence time period. The emission time period for each line after the first line can begin an emission time period duration after the start of the emission time period of the previous line. The right display 14b can also be operated as a rolling display.

If the user is moving during the display time period, the rolling display(s) can create perceived skews even when device 10 compensates for all the skew introduced by the rolling shutter image sensors. Thus, to further compensate for the skews associated with the rolling display, device 10 can also be configured to transform the second captured image 1404 to make it appear as what would be perceived by the moving user from the left eye perspective during the display time period including the second time rather than from the left camera perspective over the capture time period including the first time. Device 10 can transform the second captured image 1404 based on depth values associated with image 1404 and a difference between the left camera perspective at the first time and the left eye perspective at the second time. Furthermore, device 10 can transform the second captured image 1404 based on motion of device 10 during the capture time period to compensate for skew introduced by motion of device 10 during the capture time period. Moreover, device 10 can additionally or alternatively transform the second captured image 1404 based on motion of device 10 during the display time period to compensate for any perceived skew introduced by motion of device 10 during the display time period. Thus, device 10 can be configured to generate the transform based on a predicted motion of device 10 during the display time period to compensate for perceived skew introduced by motion of device 10 during the display time period.

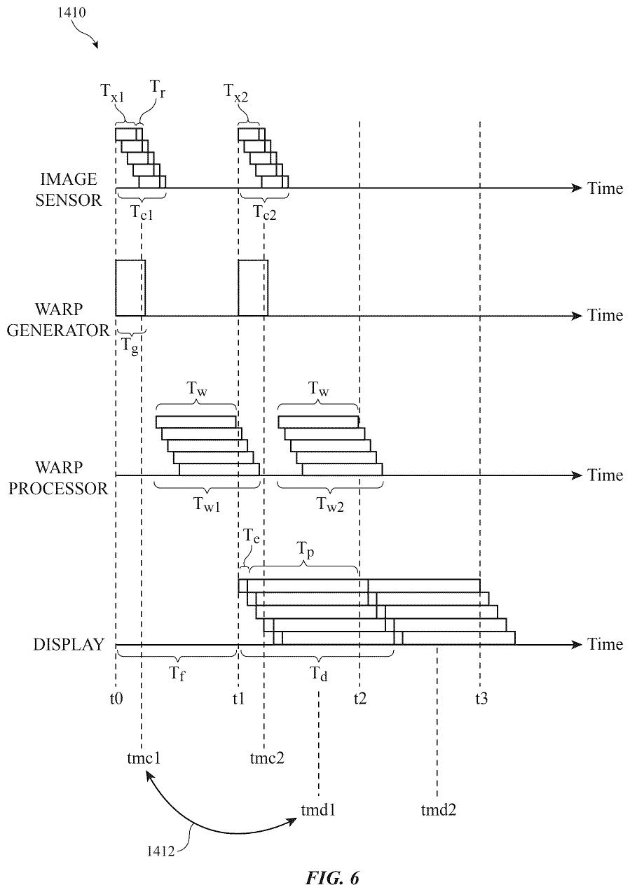

FIG. 6 is a timing diagram showing illustrative warping operations that can be performed by device 10 in accordance with some embodiments. The display timing can be partitioned into a plurality of camera frames, each frame having a frame time period duration Tf. During the first frame (e.g., from time t0 to t1=t0+Tf), an image sensor captures a first image over a first capture time period having a first capture time period duration Tc1. As described above, in various embodiments, the image sensor can be a rolling shutter camera. For example, each of n lines, five of which are illustrated in FIG. 6, of the image sensor can be exposed over a different exposure time period having first exposure time period duration Tx1. Following the exposure time period for each line, the resulting values can be read out over a corresponding readout time having a readout time duration Tr. The exposure time period for each line after the first line starts a readout time duration Tr after the start of the exposure time period of the previous line.

During the first frame, a warp generator can be configured to generate, over a first warp generation time period having warp generation duration Tg (from time t0 to t0+Tg), a first warp definition based on a predicted pose of device 10 at the first capture time (e.g., sometime during the first frame) and a predicted pose of device 10 at a first display time (e.g., during the second frame). Furthermore, beginning in the first frame, after a number of lines the first captured image have been read out, a warp processor can be configured to generate, using the first warp definition, a first warped image over a first warp processing time having a warp processing duration Tw1. In various implementations, each line can be warped over a different line warp processing time period having warp processing time period duration Tw. The line warp processing time period for each line after the first line begins a readout time duration Tr after the start of the line warp processing time period of the previous line.

During the second frame, a display can initiate output of the first warped image over a first display time period having display time period duration Td (e.g., from t1 to t1+Td). In various embodiments, the display can be a rolling display. For example, each of m lines, five of which are illustrated in FIG. 6, of the first warped image can be emitted at a different emission time period having an emission time period duration Te. Following the emission time period, the line can persist over a corresponding persistence time period having a persistence time period duration Tp. The emission time period for each line after the first line can begin an emission time period duration Te after the start of the emission time period of the previous line. Notably, because the display is a rolling display, the total display time period duration Td can be longer than the frame time period duration Tf. However, each line is displayed for a frame period duration Tf.

As described above, during the first frame, the warp generator can be configured to generate a warp definition based on a predicted pose of device 10 at a first capture time and a predicted post of device 10 at a first display time. In some embodiments, the first capture time can be the middle of the first capture time period (e.g., at tmc1=t0+Tc1/2=t0+(Tx1+n*Tr)/2, where n is an integer representing the total number of lines in the rolling shutter image sensor). Time tmc1 computed in this way is sometimes referred to and defined herein as the “mid-capture” time. In some embodiments, the first display time can be the middle of the first display time period (e.g., at tmd1=t1+Td/2=t1+(Tp+m*Te)/2, where m is an integer presenting the total number of lines in the rolling display). Time tmd1 computed in this way is sometimes referred to herein as the “mid-display time.”

During the second frame from time t1 to t2, the image sensor (e.g., a rolling shutter camera) can capture a second image over a second capture time period having second capture time period duration Tc2 (from time t1 to t1+Tc2). The second capture time period duration Tc2 can be longer or shorter than the first capture time period duration Tc1 due to a longer or shorter second exposure time period duration Tx2. For example, each of n lines, five of which are illustrated in FIG. 6, of the image sensor can be exposed over a different exposure time period having second exposure time period duration Tx2. Following the exposure time period for each line, the resulting values can be read out over a corresponding readout time having a readout time duration Tr. The exposure time period for each line after the first line starts a readout duration Tr after the start of the exposure time period of the previous line.

During the second frame, the warp generator can generate over a second warp generation time period having warp generation duration Tg (from time t1 to t1+Tg) a second warp definition based on a predicted pose of device 10 at a second capture time (e.g., sometime during the second frame) and a predicted pose of device 10 at a second display time (e.g., during the third frame). Furthermore, beginning in the second frame, after a number of lines the first captured image have been read out, the warp processor can be configured to generate, using the second warp definition, a second warped image over a second warp processing time having warp processing duration Tw2. Each line can be warped over a different line warp processing time period having warp processing time period duration Tw.

As described above, during the second frame, the warp generator can be configured to generate the second warp definition based on a predicted pose of device 10 at a second capture time and a predicted post of device 10 at a second display time. In some embodiments, the second capture time can be the middle of the second capture time period (e.g., at tmc2=t1+Tc2/2=t1+(Tx2+n*Tr)/2). Time tmc2 computed in this way is also sometimes referred to herein as the “mid-capture time.” In some embodiments, the second display time can be the middle of the second display time period (e.g., at tmd2=t2+Td/2=t2+(Tp+m*Te)/2). Time tmd2 computed in this way is also sometimes referred to herein as the “mid-display time.”During a third frame, the display can initiate output of the second warped image over a second display time period having a display time period duration Td (e.g., from time t2 to t2+Td). Although FIG. 6 illustrates some processing operations that can be applied to captured images, additional image processing operations can be performed, such as de-bayering, color correction, lens distortion correction, noise reduction, and/or blending of virtual content, just to name a few.

In accordance some embodiments, the warp generator can generate a warp definition based on a predicted pose at a capture time such as the mid-capture time and based on a predicted pose a display time such as the mid-display time. In the example of FIG. 6, the first warp definition may be based on predicted poses of device 10 at time tmc1 and tmd1, as indicated by arrows 1412. Such warping operations performed based on estimated or predicted poses of device 10 at different points in time are sometimes referred to herein as a time-based warping or “timewarp” operations. The warp processor can then warp the captured image based on the warp definition to produce a corresponding warped image in which the skew due to rolling shutter image sensors and rolling displays have been compensated. Such warping approach might be effective in certain lighting scenarios but might not be as effective in scenarios with one or more potentially flicker-causing light sources.

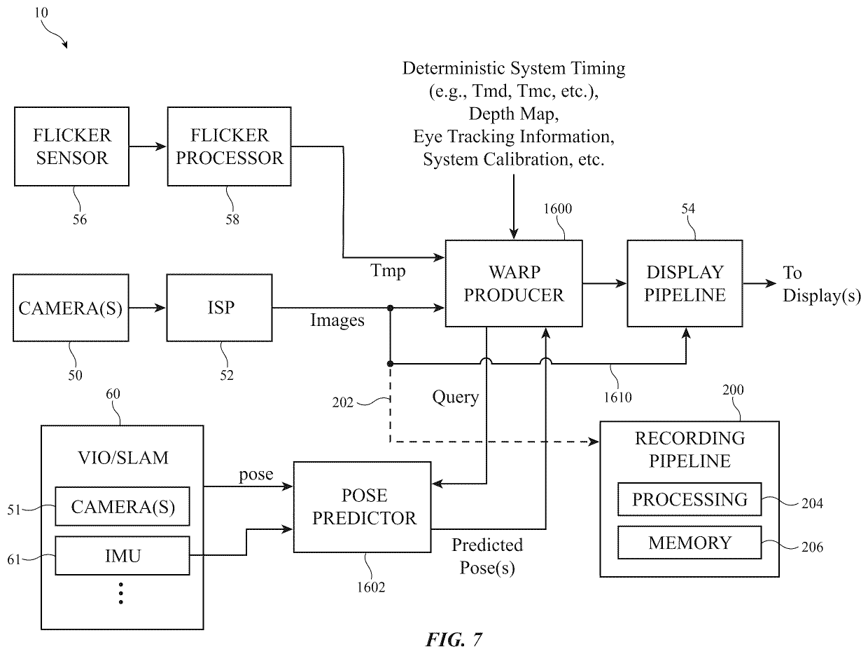

FIG. 7 is a diagram showing illustrative hardware and/or software subsystems that can be provided within device 10 for performing such type of warping operations. As shown in FIG. 7, device 10 can include one or more cameras 50, ISP block 52, one or more flicker sensor 56, flicker processor 58, VIO/SLAM block 60, a warp producing subsystem such as warp producer 1600, a pose estimation subsystem such as pose predictor 1602, and display pipeline 54. Details of cameras 50, ISP block 52, flicker sensor 56, flicker processor 58, and VIO/SLAM block 60 are already described in connection with FIG. 3 and need not be repeated here to avoid obscuring the present embodiment. Pose predictor 1602 is sometimes referred to as a pose prediction subsystem. Warp producer 1600 may be configured to generate the various warp definitions and to subsequently warp the captured images based on the warp definitions (e.g., warp producer 1600 can be configured to perform the warp generator and warp processing functions described in connection with FIG. 6). The warping functions achieved using warp producer 1600 can sometimes be referred to herein as image “transforms” or image “reprojections.”

To generate a warp definition (sometimes referred to as a transform definition), warp producer 1600 may be configured to query the pose prediction block 1602 at different times. Warp producer 1600 may be configured to receive timing information relating to the flicker-causing light source from flicker processor 58. For example, flicker processor 58 may analyze the output of flicker sensor 56 and identity or predict a “mid-pulse” time Tmp corresponding to the center or peak of one or more pulses in the flicker-causing light source (e.g., flicker processor 58 may be capable of performing a waveform maxima prediction or other peak detection operation). Flicker processor 58 may predict time Tmp based on past or recently acquired frequency and phase information (e.g., to predict a phase for a future time window based on the frequency and phase data from recent time windows). The predicted point in time Tmp may overlap with a target camera image frame being captured (e.g., time Tmp may at least partially overlap with the camera exposure time).

Warp producer 1600 may be further configured to receiving timing information such as system timing information. The system timing information may be deterministic. The deterministic timing information may include “mid-display” times Tmd (e.g., the mid-point of the rolling display time, including the display emission time periods and the display persistence time periods), “mid-capture” times Tmc (e.g., the mid-point of the rolling shutter capture, including the exposure time periods and the readout times), and/or other timing information related to the image capture operation and the display operation. In some embodiments that employ sensor foveation, the readout times of the of various image sensor rows can be different. The mid-capture time Tmc can optionally account for the varying readout times or can ignore the varying readout times. Image sensor foveation may refer to an imaging technique that involves allocating a higher resolution of a region of an image corresponding to a user's point of gaze while allocating a lower resolution to peripheral regions around the region of focus.

Warp producer 1600 may query the pose predictor 1602 using the timing information received from flicker processor 58 and/or using the deterministic timing information. In response to receiving a first time (timestamp) from warp producer 1600, pose predictor 1602 may communicate with VIO/SLAM block 60 to determine a first predicted pose of device 10 at the first time. For example, in response to receiving mid-emission time Tmp from warp producer 1600, pose predictor 1602 may employ VIO/SLAM block 60 to determine a first predicted pose of device 10 at time Tmp. VIO/SLAM block 60 may return a current pose for each camera frame captured by camera(s) 51 and can use IMU 61 to gather other associated motion data, all of which can be analyzed by pose predictor 1602 to estimate or predict a future pose of device 10 at the queried time. Similarly, in response to receiving a second time (timestamp) from warp producer 1600, pose predictor 1602 may communicate with VIO/SLAM block 60 to determine a second predicted pose of device 10 at the second time. For example, in response to receiving mid-display time Tmd from warp producer 1600, pose predictor 1602 may employ VIO/SLAM block 60 to determine a second predicted pose of device 10 at time Tmd. In general, warp producer 1600 can query pose predictor 1602 for two or more poses simultaneously (e.g., by outputting Tmp and Tmd to pose predictor 1602 in parallel) or at different times (e.g., by outputting Tmp first and then Tmd second to pose predictor 1602, or vice versa). The first predicted pose of device 10 corresponding to time Tmp is sometimes referred to as a first estimated device pose, whereas the second predicted pose of device 10 corresponding to time Tmd is sometimes referred to as a second estimated device pose.

Pose predictor 1602 can thus output, to warp producer 1600, multiple predicted poses of device 10 at the queried times. In response to receiving the predicted poses of device 10, warp producer 1600 can then generate a warp definition based on the received predicted poses and then warp one or more images provided from ISP block 52 using the warp definition to generate a corresponding warped image. Producing warped images in this way can help compensate any skew due to rolling shutter image sensors and rolling displays while mitigating flicker-related issues. Operated in this way, warp producer 1600 can be configured to generate warp definitions (e.g., to perform the functions of a warp generator described in connection with the timing of FIG. 6) and to process warped images (e.g., to perform the functions of a warp processor described in connection with the timing of FIG. 6). Thus, warp producer 1600 can sometimes be referred to as warp generation and processing circuitry. Warp producer 1600 of this type is sometimes referred to as an image warping subsystem.

The warped images output from warp producer 1600 can be conveyed to display pipeline 54. Display pipeline 54 can also receive the processed images directly from ISP block 52, as shown by data path 1610. Display pipeline 54 may generally represent any component for processing the passthrough content between ISP block 52 and display(s) 14. In general, any components that are involved in the processing and/or rendering of visual content, including real-world passthrough content or computer-generated virtual content, to be presented on the display(s) of device 10 can be considered part of the display pipeline. For example, display pipeline 54 can optionally include a media merging or blending subsystem configured to merge/composite real-world passthrough content with computer-generated virtual content.

To provide device 10 with recording capabilities, device 10 may further include a separate recording subsystem such as recording pipeline 200. As shown in FIG. 7, recording pipeline 200 may include a recorder processing block 204 and recorder memory 206. To provide flexibility in subsequent editing and/or replay of a recording, recording pipeline 200 may be configured to record a wide variety of information associated with a passthrough experience or an extended reality experience. In general, any parameters, metadata, raw content, and other information acquired by one or more components within device 10 may be recorded by recording pipeline 200. For example, the raw passthrough feed, the processed passthrough feed, and/or image sensor metadata from the image sensors 50 may be provided, via exemplary data path 202, to and recorded by the recording pipeline 200.

In some embodiments, any image signal processing (ISP) parameters used by ISP 52 (e.g., color adjustment parameters, brightness adjustment parameters, distortion parameters, and/or any other parameters used in adjusting the passthrough feed) may be provided to and recorded by recording pipeline 200. In some embodiments, virtual content output by a graphics rendering pipeline may be provided to and recorded by recording pipeline 68 (e.g., by recording the virtual content as a single layer or as multiple layers). If desired, parameters such as color adjustment parameters, brightness adjustment parameters, distortion parameters, and/or other parameters used by a virtual content compositor to generate virtual content may also be provided to and recorded by recording pipeline 200. In some embodiments, the head tracking information, gaze tracking information, and/or hand tracking information may also be provided to and recorded by recording pipeline 200. In some embodiments, a foveation parameter used in performing the dynamic foveation may also be provided to and recorded by recording pipeline 200. In some embodiments, compositing metadata associated with the compositing of the passthrough feed and the virtual content may be provided to and recorded by recording pipeline 200. The compositing metadata used and output by a media merging compositor may include information on how the virtual content and passthrough feed are blended together (e.g., using one or more alpha values), information on video matting operations, etc. If desired, audio data obtained from one or more speakers within device 10 may be provided to and recorded by the recording pipeline 200.

The information received by recording pipeline 200 may be stored in memory 206. Before or after recording the information, recording processor 204 may optionally perform additional operations such as selecting a subset of the received frames for recording (e.g., selecting alternating frames to be recorded, selecting one out of every three frames to be recorded, selecting two out of every three frames to be recorded, selecting one out of every four frames to be recorded, selecting two out of every four frames to be recorded, selecting three out of every four frames to be recorded, etc.), limiting the rendered frames to a smaller field of view (e.g., limiting the X dimension of the rendered content, limiting the Y dimension of the rendered content, or otherwise constraining the size or scope of the frames to be recorded), undistorting the rendered content since the content being recorded might not be viewed through a lens during later playback, etc.

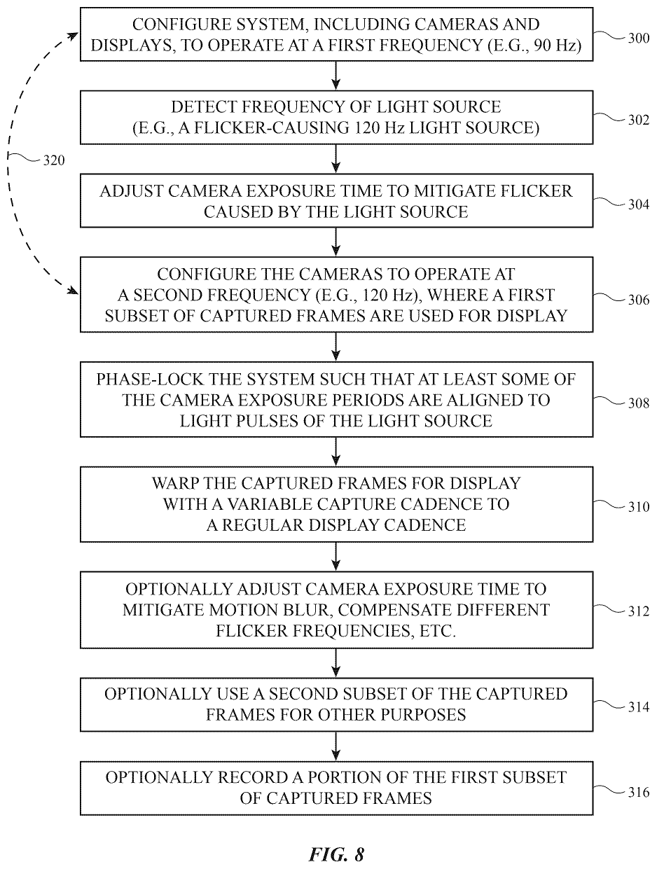

FIG. 8 is a flow chart of illustrative steps for operating an electronic device 10 of the type described in connection with FIGS. 1-7 in accordance with some embodiments. During the operations of block 300, device 10 can be configured to operate at a first frequency. For example, both camera(s) 50 and display(s) 14 can be configured to operate at a nominal system frame rate of 90 fps (frames per second). This example in which the nominal system frame rate is 90 Hz is illustrative. If desired, the nominal system frame rate can be set to 100 Hz, 30 Hz, 60 Hz, 75 Hz, 120 Hz, 144 Hz, 165 Hz, 240 Hz, 360 Hz, or other suitable frame rates. Device configurations in which the nominal system frame is set to 90 Hz is sometimes described herein as an example.

During the operations of block 302, device 10 can be configured to detect a frequency of a light source illuminating the scene facing device 10. For example, flicker processor 58 of FIG. 3 can be configured to analyze the raw sensor data received from flicker sensor 56 and to measure/compute corresponding flicker metrics such as frequency, phase, modulation depth, flicker index (e.g., a metric that considers both the modulation depth and the flicker frequency), a DC or direct current ratio (e.g., a ratio of the energy of constant light to the energy of flickering light), and other related lighting information. The frequency output from flicker processor 58 may represent the frequency of the dominant light source in the scene. The phase output from flicker processor 58 may represent the phase of the dominant light source in the scene. In some embodiments, flicker sensor 56 might be able to detect the frequency and phase of multiple light sources in the scene (e.g., flicker sensor 56 can output a respective frequency and phase for each light source detected within the physical environment). As an example, consider a scenario in which flicker processor 58 determines that the frequency of a flicker-causing light source in the scene is equal to 120 Hz. Device 10 operating at a system frame rate of 90 Hz in an environment with a 120 Hz light source can exhibit flicker-related issues in the live passthrough feed being presented on display(s) 14.

During the operations of block 304, device 10 can be configured to adjust the exposure time of camera(s) 50 to help mitigate flicker caused by the light source detected during block 302. For example, the exposure time for each line of the image capture (see, e.g., exposure time period duration Tx1 in the example of FIG. 6) can be set equal a reciprocal of the frequency of the flicker-causing light source. In the example above where the detected frequency of the flicker-causing light source is equal to 120 Hz, device 10 can set the exposure time period for the camera(s) 50 equal to 1/120 or 8.333 ms (milliseconds). In general, if the detected frequency of the flicker-causing light source is equal to f_{light}, then device 10 can set the camera exposure time to N/f_{light}, where N is some positive integer (e.g., 1, 2, 3, 4, 5, etc.).

During the operations of block 306, device 10 can configure camera(s) 50 to operate at a second frequency different than the first (nominal or initial) frequency described in block 300. For example, camera(s) 50 can be configured to operate at 120 fps to match the frequency of the 120 Hz flicker-causing light source. As another example, camera(s) can be configured to operate at a frame rate equal to f_{light} divided by some integer value (e.g., f_{light}/2, f_{light}/3, f_{light}/4, etc.). Display(s) 14 should remain operating at 90 Hz. In other words, at this point, the operating frequency of camera(s) 50 may be decoupled from the operating frequency of display(s) 14. Here, the camera frame rate may be adjusted to be different (e.g., greater) than the display frame rate. Operating the image processing pipeline (e.g., ISP block 52) at such elevated frame rate can consume more power. Since display(s) 14 in this example are only operating at 90 Hz, the camera(s) 50 only need to capture 90 out of the total 120 frames for display purposes.

In accordance with an embodiment, 30 out of 120 (or a quarter) of all captured images can be dropped at ISP 50 to reduce processing requirements and save power. This technique in which a quarter of all captured images is dropped (discarded) is sometimes referred to as 4:3 image decimation, where only three out of every four frames are being passed to the display pipeline for output. The portion of captured images being conveyed to the display pipeline for output is sometimes referred to and defined herein as a first subset of captured frames “for display.” As another example, 30 out of 120 (or a quarter) images might not even be captured by camera(s) 50 to reduce processing requirements and save power. In any case, camera(s) 50 will provide at least 90 images per second to the display pipeline, assuming display(s) 14 is operating at 90 Hz.

During the operations of block 308, device 10 can phase-lock the system such that at least some of the camera exposure periods are aligned to respective light pulses of the detected light source. For example, frequency and phase locking (FPL) controller 80 of FIG. 3 can be employed to temporally align at least some of the camera exposures to a subset of the light pulses. In a rolling shutter scheme, the overall camera exposure duration of all lines from the beginning of the first exposure to the end of the final exposure in a given camera frame is more accurately referred to as an image capture time period (see, e.g., Tc1 in FIG. 6). Referring to the example of FIG. 6, at least some the mid-capture times (see, e.g., tmc1—denoting the midpoint of the first image capture time period) of the collective exposures in each frame can be aligned to respective peaks of the light pulses in the detected light source. In the example where camera(s) 50 are operating at 90 Hz while the light source has a modulation frequency of 120 Hz, a third (⅓) of the mid-capture times can be aligned or phase-locked to a quarter (¼) of the light pulses.

Although FIG. 8 illustrates the operations of blocks 304, 306, and 308 as proceeding in a particular order, the order of these blocks can be altered. In general, once flicker is detected from block 302, device 10 can synchronously adjust the frame cadence (e.g., block 306), phase (block 308), and exposure time (block 304) or can perform these operations in any order. If desired, device 10 can dynamically toggle or switch between the mode of block 300 (e.g., a first default mode with a regular capture cadence) and the mode of block 306 (e.g., a second mode with an irregular 4:3 decimated frame cadence), as illustrated by dotted arrows 320. This dynamic mode toggling can be performed based on a detected head motion/pose, the current use case of device 10, gaze tracking data, other sensor data, and/or other parameters to mitigate judder for one or more moving objects in the scene. In scenarios where device 10 dynamically toggles from the regular frame cadence mode of block 300 to the decimated frame cadence mode of block 306, it may be desirable to perform the exposure time adjustment of block 304 before the mode transition to avoid undesired artifacts.

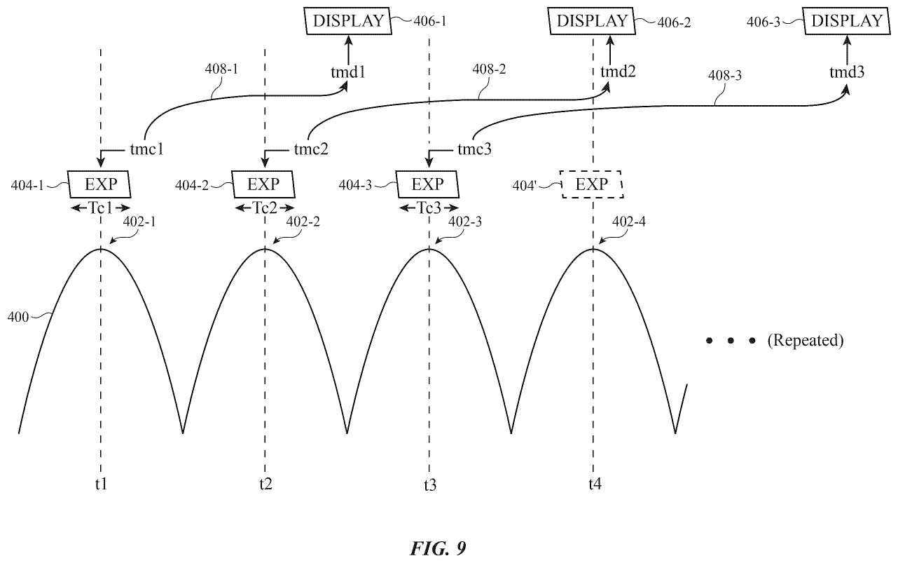

During the operations of block 310, device 10 can transform or warp only the first subset of captured frames for display in accordance with a scheme illustrated in FIG. 9. FIG. 9 is a timing diagram showing illustrating warping operations that can be performed continuously following the operations of block 308. Waveform 400 represents the light pulses of the detected light source. As an example, waveform 400 is a 120 Hz light source, having a first peak 402-1 at time t1, a second peak 402-2 at time t2 following the first peak 402-1, a third peak 402-3 at time t3 following the second peak 402-2, a fourth peak 402-4 at time t4 following the third peak 402-3, and so on. Here, since capture time periods were previously phased-locked to the peaks of light source 400 during the operations of block 306 and since the camera(s) 50 have be adjusted to operate at the second frequency (e.g., 120 fps) to match the frequency of the 120 Hz light source 400 during the operations of block 308, the capture time periods of successive frames will be temporally aligned to respective peaks of light source 400. In the rolling shutter example of FIG. 9, the first group of rolling exposures 404-1 may have a first overall capture time period duration Tc1 with a corresponding first mid-capture time tmc1 that is aligned to peak 402-1; the second group of rolling exposures 404-2 may have a second overall capture time period duration Tc2 with a corresponding second mid-capture time tmc2 that is aligned to peak 402-2; the third group of rolling exposures 404-3 may have a third overall capture time period duration Tc3 with a corresponding third mid-capture time tmc3 that is aligned to peak 402-3; and so on. Camera(s) 50 can optionally be configured to obtain a fourth group of rolling exposures 404′ that is aligned to peak 402-4, which can be dropped to save power or otherwise processed for other purposes (see, e.g., operations of block 314).

As described above, display(s) 14 is configured to operate at the first (nominal) frequency of 90 Hz. FIG. 9 illustrates successive display time periods at a regular display cadence of 90 Hz (e.g., where successive display time periods are spaced apart by 1/90 or 11.111 ms). Each of the various display time periods 406 shown in FIG. 9 can include the emission time period Te and/or the display persistence time period Tp described in connection with FIG. 6. In the rolling display example of FIG. 9, the first display time period 406-1 can have a corresponding first mid-display time tmd1; the second display time period 406-2 can have a corresponding second mid-display time tmd2; the third display time period 406-3 can have a corresponding third mid-display time tmd3; and so on. In general, FIG. 9 shows show the images can be captured for display at a first cadence (e.g., at time t1, t2, and t3 while optionally skipping t4), whereas the images can be displayed at a second cadence different than the first cadence (e.g., the intervals between successive display time periods 406 are different than the intervals between successive image capture periods).

Here, the first image captured at around time t1 will be displayed during display time period 406-1. Thus, the warping operations performed during block 310 can use a first warp definition that is generated based on a first predicted or estimated pose at first mid-capture time tmc1 and a second predicted or estimated pose at first mid-display time tmd1, as indicated by arrow 408-1, to warp the first captured image. Similarly, the second image captured at around time t2 will be displayed during display time period 406-2. Thus, the warping operations performed during block 310 can use a second warp definition that is generated based on a third predicted or estimated pose at second mid-capture time tmc2 and a fourth predicted or estimated pose at second mid-display time tmd2, as indicated by arrow 408-2, to warp the second captured image. Similarly, the third image captured at around time t3 will be displayed during display time period 406-3. Thus, the warping operations performed during block 310 can use a third warp definition that is generated based on a fifth predicted or estimated pose at third mid-capture time tmc3 and a sixth predicted or estimated pose at third mid-display time tmd3, as indicated by arrow 408-3, to warp the third captured image. The example described here in which the various warping operations are performed based on the predicted/estimated head pose (e.g., head motion) is illustrative. If desired, certain moving portions of each captured image/frame can be selectively warped by a different amount than what is required for the head motion. As examples, moving hands, moving people, and/or other moving objects within the captured scene can be warped by different amounts to mitigate judder for those particular portions of the frame.

Since some of the exposures such as exposures 404′ are not being used for display, the capture cadence can be considered “variable.” For instance, the delta between t1 and t2 can be equal to the delta between t2 and t3. However, the delta between t3 and the next capture of an image for display can be equal to two times the delta between t1 and t2 since the image capture at time t4 is not being used for display. Configured to operate in this way, the capture cadence can be considered variable, uneven, or “irregular.” In conjunction with a different display frame rate, this results in a scenario illustrated in FIG. 9 where the timing between tmc1 and tmd1 has a first delta, where the timing between tmc2 and tmd2 has a second delta greater than the first delta, and where the timing between tmc3 and tmd3 has a third delta even greater than the second delta. The first delta is sometimes referred to and defined herein as a first (base) capture-to-display latency. The base capture-to-display latency can be a function of the exposure time duration. The second delta is sometimes referred to as a second capture-to-display latency that is equal to the base capture-to-display latency plus an offset that is a function of the first and second frequencies (e.g., the offset can be equal to 1/90− 1/120=2.77 ms). The third delta is sometimes referred to as a third capture-to-display latency that is equal to the base capture-to-display latency plus two times the offset (e.g., 2*2.77 ms=5.55 ms). These values are merely illustrative and can be extended to other camera and display operating frequencies. The timing of FIG. 9 can be repeated for each group of three frames being displayed by device 10. Performing warping operations in this way can be technically advantageous and beneficial to mitigate flicker-related issues.

Device 10 can employ the warp producer 1600 of the type described in connection with FIG. 7 to perform such warping operations. Each warp definition may define a mapping between a two-dimensional (2D) unwarped space of the captured image and a 2D warped space of a corresponding warped image. The warp definition can include a warp mesh. The warp definition, when applied, can compensate for a difference in perspective between the camera and an eye of a user (e.g., by reprojecting the captured image from a first perspective of the image sensor to a second perspective to the user). For example, the second perspective can be a perspective from a location closer to the eye of the user in one or more dimensions of a 3-dimensional (3D) coordinate system of device 10.

The warp definition can compensate for distortions or skew introduced by a motion of device 10 during the strobe or light pulse of the flicker-causing light source. Accordingly, the warp definition can be further based on the predicted motion of device 10 during the light pulse. The warp definition can also compensate for any perceived distortions or skew introduced by the motion of device 10 during the display time period. Accordingly, the warp definition can be further based on the predicted motion of device 10 during the display time period, including at least the display time. The warp definition can optionally compensate for distortions or skew introduced by the motion of device 10 during the capture time period. Accordingly, the warp definition can be further based on the predicted motion of device 10 during the capture time period, including at least the capture time. If desired, the warp definition can further compensate for other distortions, such as distortions caused by a lens of the image sensor, distortions caused by a lens of the display, distortions caused by foveation, distortion caused by compression, or other types of visual distortion. In certain embodiments, the warp definition can also be adjusted to compensate for judder caused by an uneven input frame rate for moving hands, moving people, and/or other moving object(s) in a scene.

To that end, the warp definition can be further generated based on a depth map, including a plurality of depths respectively associated with an array of pixels in the captured image of the physical environment. Device 10 can obtain the plurality of depths using one or more depth sensors, which can be included as part of sensors 16 in FIG. 2. Additionally or alternatively, device 10 can obtain the plurality of depths using stereo matching operations (e.g., using the image of the physical environment as captured by a left image sensor and using the image of the physical environment as captured by a right image sensor). Additionally or alternatively, device 10 can obtain the plurality of depths from a 3D scene model of the physical environment (e.g., via rasterization of the 3D model or via ray tracing based on the 3D model). If desired, device 10 can determine the depth map based on the predicted capture pose or based on the predicted strobe pose. If desired, device 10 can determine the depth map before the capture time period and/or before the strobe time. Thus, device 10 can generate the warp definition before the capture time period. In some embodiments, the warp definition can further be generated based on eye tracking information (e.g., gaze information obtained from inward-facing cameras 42 of FIG. 1), system calibration information, and/or other system parameters.

In some embodiments, the warped image can include XR content. The XR content can be added to the captured image before the warping operations of block 310. Alternatively, the XR content can be added to the warped image (e.g., after the warping operations of block 310). The XR content can be warped according to the warp definition generated from block 310 before being added to the warped image. In some embodiments, different sets of XR content can be added to the captured image before the warping and after the warping operations. For example, world-locked content can be added to the captured image, whereas display-locked content can be added to the warped image. “World-locked” content can refer to virtual objects that remain at the same, fixed position in the physical environment, regardless of the motion of the user wearing device 10. In contrast, “display-locked content” can refer to virtual objects that remain fixed in a portion of the user's field of view at a particular distance as the user moves his/her head (e.g., the display-locked content is fixed at a given position relative to device 10 and remains in the same portion of the user's field of view even as the user turns his/her head). Display-locked content is therefore sometimes also referred to as “head-locked content.”

During the operations of block 312, device 10 can optionally be configured to reduce the exposure time to reduce motion blur, to adjust the exposure time to compensate different flicker frequencies (e.g., in scenarios where the physical environment includes more than one light source with different modulation frequencies), and/or make other image sensor adjustments to mitigate flicker-related issues. When reducing exposure times to mitigate motion blur, a sensor gain of camera(s) 50 can be raised accordingly to maintain the brightness of the captured images. In certain scenarios, the required gain can change across a frame due to flicker. In such scenarios, there can be a corrective two-dimensional gain map (e.g., a 2D brightness and color correction map) that is applied to compensate the uneven brightness and color variation. If desired, blending with one or more previously captured frames can also be employed. Although the operations of block 312 are shown as occurring after block 310, the operations of block 310 can be performed in parallel with the operations of block 312.

During the operations of block 314, device 10 can optionally be configured to use a second subset of the captured frames for other purposes. The second subset of the captured frames are not directly used for display purposes. In the example of FIG. 9, the image captured using exposures 404′ at around time t4 can be selectively dropped to save processing power. If desired, the image at time t4 might not even be captured to minimize power consumption. Although the operations of block 314 are shown as occurring after block 312, the operations of block 314 can be performed in parallel with the operations of block 310 and/or block 312. In general, the operations of block 302, 304, 308, 310, 312, and 314 can represent processes that are always running.

In some embodiments, an image can be opportunistically captured at time t4 for further evaluation. In the example described herein in which 30 out of every 120 images are being decimated or bypassed from the display output, such non-display images—sometimes referred to and defined herein as “ghost” images—can be used by device 10 for evaluating different exposure times (e.g., the exposure time for exposures 404′ can be different than the other exposure times 404-1, 404-2, and 404-3 to determine whether a longer or shorter exposure duration is beneficial), for evaluating different sensor gain settings (e.g., to experiment with different camera gain levels), clipping evaluation (e.g., to determine how much or which portions of a scene might clip), brightness estimation, high dynamic range (HDR) recovery (e.g., the ghost frames can be composited with the other display frames to recover shadow and highlight details), calculating or generating a two-dimensional (2D) brightness and color correction map, and/or for other types of image evaluation or enhancement.

Generally, a first subset of the images being output on the one or more displays at the display frequency (e.g.,, images displayed during display time periods 406-1, 406-2, and 406-3 and captured at times t1, t2, and t3, respectively) can be captured using a first set of image sensor settings while a second subset of the images (e.g., the ghost image captured at time t4) can be captured using a second set of image sensor settings at least partially different than the first set of image sensor settings. If desired, the ghost frames can be passed to various downstream algorithms or clients for further processing. For example, one or more of the ghost frames can be conveyed to SLAM block 60 (see FIG. 3), one or more of the ghost frames can be conveyed to a client configured to perform low light recovery, one or more of the ghost frames can be conveyed to a hands tracking subsystem, just to name a few.

During the operations of block 316, a portion of the first subset of captured frames can optionally be recorded by the recording pipeline 200 of FIG. 7. In other words, only a subset of the captured frames for display might be recorded. For example, consider a scenario in which images are being captured by camera(s) 50 at a 120 Hz frame rate. In the scenario where a 4:3 decimation mode is employed during block 306, only three out of every four frames are being used for passthrough on the display to reduce power. For recording purposes, a subset of the of the remaining passthrough frames can be processed by subsystem 204 and stored in memory 206. In one embodiment, two of the three remaining non-decimated frames can be used to obtain a 60 Hz recording. In another embodiment, one of the three remaining non-decimated frames might be used to obtain a 30 Hz recording. In general, any subset of the passthrough frames can be sampled for recording purposes. Operated in this way, the recording frame rate will be different or less than the display/passthrough frame rate. Although FIG. 8 shows block 316 as occurring after block 314, the operations of block 316 can run continuously in the background whether device 10 is configured to operate in the regular capture cadence mode of block 300 or the irregular decimated capture cadence mode of block 306.

The operations of FIG. 8 are illustrative. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

The methods and operations described above in connection with FIGS. 1-9 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., the storage circuitry within control circuitry 20 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., one or more processors in control circuitry 20). The processing circuitry may include microprocessors, application processors, digital signal processors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

To help protect the privacy of users, any personal user information that is gathered by sensors may be handled using best practices. These best practices including meeting or exceeding any privacy regulations that are applicable. Opt-in and opt-out options and/or other options may be provided that allow users to control usage of their personal data.

What is claimed is:

1. A method of operating a head-mounted device, comprising:
with one or more image sensors, capturing first images of a physical environment at a first frequency;
determining a frequency of a light source in the physical environment;
configuring the one or more image sensors to capture second images of the physical environment at a second frequency different than the first frequency based on the frequency of the light source; and
with one or more displays, outputting warped images at a display frequency different than the second frequency, wherein the warped images are produced by warping a subset of the second images based on poses of the head-mounted device in the physical environment at times corresponding to when the subset of the second images are being captured at the second frequency and based on poses of the head-mounted device in the physical environment at times corresponding to when the warped images are being output on the one or more displays at the display frequency.

2. The method of claim 1, wherein the second frequency at which the second images are being captured by the one or more image sensors is equal to the frequency of the light source or the frequency of the light source divided by an integer.

3. The method of claim 1, wherein the display frequency is less than the second frequency at which the second images are being captured by the one or more image sensors.

4. The method of claim 1, wherein the display frequency is equal to the first frequency at which the first images are being captured by the one or more image sensors prior to configuring the one or more image sensors to operate at the second frequency.

5. The method of claim 1, further comprising:
subsequent to determining the frequency of the light source, adjusting an exposure time for capturing the first images based on the frequency of the light source.

6. The method of claim 5, further comprising:
aligning capture time periods for at least some of the first images to respective peaks of the light source.

7. The method of claim 1, wherein after configuring the one or more image sensors to capture second images of the physical environment at the second frequency, capture time periods of the second images are aligned to respective peaks of the light source.

8. The method of claim 7, wherein warping the subset of the second images comprises:
warping a first image in the subset of the second images using a first warp definition generated based on a pose of the head-mounted device in the physical environment at a first mid-capture time of the first image and based on a pose of the head-mounted device at a first mid-display time of the first image;
warping a second image in the subset of the second images using a second warp definition generated based on a pose of the head-mounted device in the physical environment at a second mid-capture time of the second image and based on a pose of the head-mounted device at a second mid-display time of the second image; and
warping a third image in the subset of the second images using a third warp definition generated based on a pose of the head-mounted device in the physical environment at a third mid-capture time of the third image and based on a pose of the head-mounted device at a third mid-display time of the third image.

9. The method of claim 8, wherein:
a difference between the first mid-display time and the first mid-capture time is equal to a base capture-to-display latency; and
a difference between the second mid-display time and the second mid-capture time is equal to the base capture-to-display latency plus an offset that is a function of the display frequency and the second frequency.

10. The method of claim 9, wherein a difference between the third mid-display time and the third mid-capture time is equal to the base capture-to-display latency plus at least two times the offset.

11. The method of claim 7, wherein warping the subset of the second images comprises warping a given image by a first amount based on poses of the head-mounted device in the physical environment and warping a portion of the given image by a second amount different than the first amount to mitigate judder in the portion of the given image.

12. The method of claim 1, further comprising:
subsequent to configuring the one or more image sensors to capture second images of the physical environment at the second frequency, mitigating motion blur by reducing an exposure time for capturing at least the subset of the second images.

13. The method of claim 1, further comprising:
subsequent to configuring the one or more image sensors to capture second images of the physical environment at the second frequency, mitigating flicker by adjusting an exposure time for capturing at least the subset of the second images.

14. The method of claim 1, further comprising:
dropping another subset of the second images different than the subset of the second images, wherein the another subset of the second images are not being output on the one or more displays.

15. The method of claim 1, further comprising:
using another subset of the second images different than the subset of the second images for one or more of: exposure time evaluation, image sensor gain evaluation, clipping evaluation, high dynamic range (HDR) recovery, and two-dimensional brightness and color correction map generation.

16. The method of claim 15, wherein the subset of the second images are captured using first exposure times or a first image sensor gain, and wherein the another subset of the second images are captured using second exposure times different than the first exposure times or a second image sensor gain different than the first image sensor gain.

17. The method of claim 1, further comprising:
with a recording pipeline, generating a recording by storing only a portion of the subset of the second images.

18. A method of operating a head-mounted device, comprising:
detecting a light source in a physical environment and determining a frequency of the light source;
with one or more image sensors, capturing images of the physical environment while capture time periods used for capturing the images are aligned to peaks of the light source; and
with one or more displays, outputting a first subset of the images at a display frequency different than the frequency of the light source, wherein the first subset of the images being output on the one or more displays at the display frequency are being captured using a first set of image sensor settings while a second subset of the images, different than the first subset of the images, are being captured using a second set of image sensor settings at least partially different than the first set of image sensor settings.

19. The method of claim 18, wherein the second subset of the images captured using the second set of image sensor settings are not being output on the one or more displays.

20. The method of claim 18, further comprising warping the first subset of images by:
warping a first image in the first subset of the images using a first warp definition generated based on a pose of the head-mounted device in the physical environment at a first mid-capture time of the first image and based on a pose of the head-mounted device at a first mid-display time of the first image;
warping a second image in the first subset of the images using a second warp definition generated based on a pose of the head-mounted device in the physical environment at a second mid-capture time of the second image and based on a pose of the head-mounted device at a second mid-display time of the second image; and
warping a third image in the first subset of the images using a third warp definition generated based on a pose of the head-mounted device in the physical environment at a third mid-capture time of the third image and based on a pose of the head-mounted device at a third mid-display time of the third image.

21. A method of operating a head-mounted device in a physical environment, comprising:
with one or more cameras, capturing images at a first cadence;
with one or more displays, outputting a first subset of the images at a second cadence different than the first cadence;
selectively dropping a second subset of the images different than the first subset of the images; and
warping the first subset of the images based on capture times of the first subset of the images and based on display times of the first subset of the images on the one or more displays prior to outputting the first subset of the images on the one or more displays.

22. The method of claim 21, further comprising:
aligning the capture times of the images to peaks of a light source detected within the physical environment, wherein warping the first subset of the images comprises:
warping a first image of the images using a first warp definition generated based on a pose of the head-mounted device in the physical environment at a first mid-capture time of the first image and based on a pose of the head-mounted device at a first mid-display time of the first image, wherein a difference between the first mid-display time and the first mid-capture time is equal to a first capture-to-display latency; and
warping a second image of the images using a second warp definition generated based on a pose of the head-mounted device in the physical environment at a second mid-capture time of the second image and based on a pose of the head-mounted device at a second mid-display time of the second image, wherein a difference between the second mid-display time and the second mid-capture time is equal to a second capture-to-display latency different than the first capture-to-display latency.
